(19) United States
(12) Patent Application Publication
(10) Pub. No.: US 2021/0139717 A1
(43) Pub. Date: May 13, 2021

(54) HYDROPHOBIC COATINGS COMPRISING HYBRID MICROSPHERES WITH MICRO/NANO ROUGHNESS

(71) Applicant: NITTO DENKO CORPORATION, Osaka (JP)

(72) Inventors: Kaoru Ueno, Fallbrook, CA (US); Guang Pan, Carlsbad, CA (US); Bin Zhang, San Diego, CA (US)

(21) Appl. No.: 17/057,565

(22) PCT Filed: May 31, 2019
(86) PCT No.: PCT/US2019/034862

§ 371 Date: Nov. 20, 2020

Related U.S. Application Data
(60) Provisional application No. 62/678,892, filed on May 31, 2018.

(51) Int. Cl. C09D 7/40; C09D 169/00; C09D 125/06; C08L 25/06; C08L 69/00

(52) U.S. Cl. CPC C09D 7/69; C09D 7/67; C09D 7/68; C08K 3/346; C09D 125/06; C08L 25/06; C08L 69/00; C09D 169/00

(57) ABSTRACT

Described herein are coatings based on a hydrophobic polymer matrix, hydrophobic nanoparticles and hydrophilic nanoparticles, that provide a damage tolerant hydrophobic, superhydrophobic, and/or snowphobic capability, wherein the nanoparticles can comprise modified and non-modified phyllosilicate nanoclays and modified silicon dioxide. Methods of creating snow resistant materials by employing the aforementioned coatings are described. The micro and nano roughness of the composite surface is also described.

### CROSS-REFERENCE TO RELATED APPLICATIONS

This application claims the benefit of U.S. Provisional Application No. 62/678,892, filed May 31, 2018, which is incorporated by reference herein in its entirety.

### FIELD

The present disclosure relates to hydrophobic, superhydrophobic and snowphobic composites, including coatings of said composites for such uses as water, ice and snow repellents.

### BACKGROUND

In many settings, the buildup of water, ice, and snow can create undesirable results. These issues can include corrosion due to water intrusion, loss of visibility due to water buildup, and ice and snow buildup on roads, vehicles and buildings. On windshields of motor craft such as automobiles, boats, and aircraft, complex systems including wipers, air jets, and passive systems such as deflectors, are designed to remove water. The buildup of ice on the leading edges and on the upper wing surfaces of airplanes and rotor blades of helicopters can create hazardous conditions by changing the shape of the wing and/or increasing the total weight, resulting in stall or loss of performance. In addition, deposited ice can suddenly dislodge resulting in an unexpected change in characteristics and possibly loss of control. Ice and snow buildup on walkways, roadways, and bridges is inherently dangerous due to loss of traction. Highway overpasses, bridges, and power lines may create hazardous conditions by falling ice and snow, resulting in damage to vehicles and personal injury to persons below.

There are many kinds of snow and they comprise vastly divergent water contents. For example, dry or light snow comprises a very low water content, while heavy or wet snow has a high water content. The considerable difference in water content creates a problem with respect to anti-snow performance of known hydrophobic coatings. Wet snow creates a water layer between the conventional hydrophobic coatings and the snow which allows the hydrophobic coating to interact with the water, and due to the high water contact angle the water layer will slide off the coating taking along the upper layer of snow. Dry snow on the other hand, with its low water content, forms minimal to no water layer between the snow and known hydrophobic coatings. This lack of a water layer causes the dry snow to accumulate on the surface.

To combat ice and snow accretion on roadways, signage and power lines, many municipalities use anti-snow/anti-ice materials such as fluorinate resin based coatings. While some of these coatings are commercially available (e.g., HIREC100), they can be expensive to produce, difficult to work with, and may be harmful to both animals and humans.

As a result, there is a continuing need for a new anti-snow surface coating with improved hydrophobic performance, reduced cost, and low toxicity.

### SUMMARY

The present disclosure generally relates to composites. More particularly, but not exclusively, the present disclosure relates to a composite having microspheres dispersed within and protruding through a polymer matrix. In some embodiments, the present disclosure relates to a composite coating comprising a micro/nano rough surface thereof. In some examples, a hydrophobic coating comprising the polymer/microsphere composite is described.

Some embodiments include a composite comprising: a plurality of microspheres having: 1) a core comprising a first polymer, and 2) a hydrophobic coating, comprising a plurality of hydrophobic nanoparticles, and disposed upon the surface of the core; a second polymer, wherein the plurality of microspheres are at least partially dispersed within the second polymer; wherein the second polymer is immiscible in the first polymer; and wherein the first surface energy is higher than the second surface energy.

Some embodiments include a coating comprising the composite described herein, wherein the coating is hydrophobic, superhydrophobic, or snowphobic.

Some embodiments include a method for preparing a composite coating described herein, comprising: mixing a solvent and a polymer having a surface energy less than or equal to 22 mJ/m² to create a first liquid mixture; mixing hydrophilic nanoparticles into the first liquid mixture to form a second liquid mixture; mixing hydrophobic nanoparticles into the second liquid mixture to form a third liquid mixture; adding a polymer having a surface energy of at least 30 mJ/m² to the third liquid mixture to form a final liquid mixture; and adding ceramic milling media to the final liquid mixture and mixing for at least 16 hours.

Some embodiments include a method of surface treatment comprising applying a composite described herein to a surface in need of treatment.

### BRIEF DESCRIPTION OF THE DRAWINGS

FIG. 1 is a depiction of a microsphere encapsulated by hydrophobic nanoparticle, with and without hydrophilic nanoparticle in the core.

FIG. 2 is a drawing depiction of a possible embodiment of a coating with a micro/nano rough surface.

FIG. 3 is a SEM photographs depicting a micro/nano rough surface of an embodiment in differing scale.

FIG. 4 is a depiction and corresponding SEM photograph comparing micro/nano roughness on the surface of a possible embodiments.

FIG. 5. Is a representation of the snow sliding test.

### DETAILED DESCRIPTION

A composite coating is described herein. The composite can comprise a polymer matrix comprising a low surface energy polymer and optionally, a high surface energy polymer that is immiscible or incompatible with the low surface energy polymer. In some embodiments, the composite can comprise a plurality of microspheres. In some embodiments, the microspheres can be dispersed throughout, within and upon the matrix's outer surface. In some embodiments, the microspheres can comprise a core. In some embodiments, the core can comprise a high surface energy polymer, and optionally, hydrophilic nanoparticles. In some embodiments, the core can comprise a hydrophobic coating, which optionally comprises a plurality of hydrophobic nanoparticles disposed upon a surface (e.g. the circumferential surface) of the core. In some embodiments, at least some of the hydrophobic nanoparticles can extend outward from the surface of the microsphere. In some embodiments, there may be cavities between the nanoparticles. In some embodiments, the hydrophilic nanoparticles can comprise an inorganic materials such as phyllosilicate nanoclay. In some embodiments, the hydrophobic nanoparticles can comprise silicon dioxide or a perfluorinated inorganic material. In some embodiments, the hydrophobic nanoparticles can comprise a hydrophobized hydrophilic material. In some embodiments, the hydrophobized material can composite a perfluorinated phyllosilicate nanoclay. In some embodiments, the composite can be hydrophobic. In other embodiments, the composite can be superhydrophobic. In still other embodiments, the composite can be snowphobic. Some embodiments include a coating can comprising the composite. In some embodiments, the hydrophobic nanoparticle encapsulated microspheres form a micro/nano roughness on a surface of the coating.

The present disclosure relates to hydrophobic, superhydrophobic, and/or snowphobic composites that can be useful as coatings for anti-ice and anti-snow applications. “Hydrophobic” and “superhydrophobic” composites include composites that are hydrophobic, highly hydrophobic, or water repellant. Water repellency may be measured by the contact angle of a droplet of water on a surface. If the water, contact angle is at least 90° it is said to be hydrophobic. If the water, contact angle is at least 150° it is said to be superhydrophobic.

“Bulk phobicity,” such as “bulk hydrophobicity,” “bulk superhydrophobicity,” or “bulk snowphobicity” with respect to composites, coatings, paints, etc., means that the material exhibits hydrophobic, superhydrophobic and/or snowphobic properties throughout the composite, coating, paint, etc., and not only on the surface. This may provide an advantage, in that, if the surface is eroded or ablated, the remaining surface retains its phobicity. Thus, some bulk composites described herein are damage tolerant such that the phobic properties are retained after being eroded or otherwise damaged.

One way to determine whether a composite has bulk hydrophobicity and/or bulk superhydrophobicity is by removing the surface and some amount of the underlying material by abrasion, and measuring the contact angle after abrasion. For example, the contact angle may be measured after 5-8 μm, 5-6 μm, 5 μm, 6 μm, 6-7 μm, 7 μm, 7-8 μm, or 8 μm of the material from the surface has been removed by abrasion. In some embodiments, the composite retains or gains its superhydrophobic properties (e.g., a contact angle of at least 150 degrees) after abrasion.

“Snowphobic,” or snow phobicity, as used herein refers to composites wherein snow, with water content in the range of 0-20 wt % and snow loading of 1.0 g/cm², will slide off a composite treated substrate with an inclining angle of 30° or greater within 1-3 minutes of the snow accumulation. Not only will the snow slide off the treated substrate, but the treated substrate will experience less than 20% area coverage with snow prior to the snow sliding.

As used herein the term “compatibilization” has the meaning known by those of ordinary skill in the art. Compatibilization refers to a substance that when added to an immiscible (or incompatible) blend of polymers, increases the stability of the polymer blend by creating interactions between the two immiscible polymers.

Some embodiments include composites useful in repelling water, snow and/or ice. In some embodiments, the composite can be a coating. In some embodiments, the coating can have a thickness in a range of about 10-1000 μm, about 10-20 μm, about 20-25 μm, about 25-30 μm, about 30-35 μm, about 35-40 μm, about 40-45 μm, about 45-50 μm, about 50-60 μm, about 60-70 μm, about 70-80 μm, about 80-100 μm, about 100-120 μm, about 20 μm, about 25 μm, about 30 μm, about 35 μm, about 46 μm, about 79 μm, or about 106 μm.

Some embodiments include composites useful in repelling water, snow and/or ice. In some embodiments, a composite may at least have no snow adhesion, where snow keeps sliding off the test area. In some embodiments, a composite may at least have snow crystals adhering to the surface but sliding off the surface after about every 10 seconds of accumulation with an average coverage area of about 20%. In some embodiments, a composite may at least have snow crystals adhering to the surface with snow sliding off after about every 30 seconds to 1 minute of accumulation. In some embodiments, a composite may at least have the average snow accumulation on more than 80% of the test area with snow sliding after every 3-5 minutes of accumulation. In some embodiments, a composite may exhibit the aforedescribed snow adhesion at 30°, 45°, and/or 60° surface angle.

Some embodiments include a composite comprising a polymer matrix. In some embodiments, the matrix can comprise a high surface energy polymer. In some embodiments, the matrix can comprise a low surface energy polymer. In some embodiments, the composite can comprise a plurality of microspheres. In some embodiments, at least some of the microspheres are dispersed in the matrix surface or external facing. In some embodiments, the microspheres can comprise a core and a coating. In some embodiments, the core can have a first core surface. In some embodiments, the coating can be hydrophobic.

In some embodiments, the core can comprise hydrophilic nanoparticles and the high surface energy polymer. In some embodiments, the core can comprise the high surface energy polymer. In some embodiments, the hydrophobic modified surface can comprise a fluorinated metal silicate. In some embodiments, the fluorinated metal silicate can be a fluorinated aluminum silicate and/or a fluorinated magnesium aluminum silicate. In some embodiments, the coating can comprise a plurality of hydrophobic nanoparticles disposed upon the core surface. In some embodiments, at least some of the microspheres can be dispersed within the surface of the polymer matrix.

In some embodiments, the composite can be in any suitable form, such as a solid, e.g., a composite solid or a homogeneous solid. For example, various components of the composite can be mixed such that they form a substantially uniform mixture. In some embodiments, components of the composite can be crosslinked, and may, for example form a material matrix. In some embodiments, some of the materials can be loaded into the matrix. In some embodiments, the composite can form a coating, e.g., a paint, an epoxy, powder coating, etc.

Polymer Matrix

Some embodiments include a polymer matrix having a first or outer matrix surface. In some embodiments, the surface opposite to the outer matrix surface is a surface bound to a substrate. In some embodiments, the matrix can comprise a high surface energy polymer. In some embodiments, the high surface energy polymer can have a surface energy of at least about 30 mJ/m² (for the purposes of this disclosure, mJ/m² and mN/m are considered to be equivalent and may be used interchangeably as the dimensional formula of surface energy). In some embodiments, the matrix can further comprise a low surface energy second polymer. In some embodiments, the low surface energy polymer can have a surface energy of about 24 mJ/m² or less or about 22 mJ/m² or less. In some embodiments, the high surface energy polymer and the low surface energy polymer can have sufficiently dissimilar surface energy to cause the first hydrophobic polymer and the second hydrophobic polymer to be immiscible within each other. In some embodiments, the high surface energy polymer and the low surface energy polymer can have sufficiently dissimilar surface energy to cause the first hydrophobic polymer and the second hydrophobic polymer to be largely incompatible with each other.

Any suitable low surface energy polymer may be used in the composite, such as a polydimethylsiloxane (PDMS, or a silicone, [19.8 mN/m at 20° C.]), a polytrifluoroethylene (P3FEt/PTrFE, [23.9 mN/m at 20° C.]), or a polytetrafluoroethylene (PTFE/Teflon™ [20 mN/m at 20° C.]).

In some embodiments the low surface energy polymer can comprise an organosilicon material. In some embodiments, the organosilicon material can be an alkylsilane. In some embodiments, the alkylsilane can be polydimethylsilane (polydimethylsiloxane) (PDMS). In some embodiments, the PDMS may be a suitable commercially available embodiment, for example Sylgard° 184 (DOW Corning, Midland, Mich. USA).

In some embodiments, the low surface energy polymer has a surface energy of about 15-25 mN/m, about 15-16 mN/m, about 16-17 mN/m, about 17-18 mN/m, about 18-19 mN/m, about 19-20 mN/m, about 20-21 mN/m, about 21-22 mN/m, about 22-23 mN/m, about 23-24 mN/m, about 24-25 mN/m, about 15-17 mN/m, about 17-19 mN/m, about 19-21 mN/m, about 21-23 mN/m, about 23-25 mN/m, about 15-18 mN/m, about 18-21 mN/m, about 21-25 mN/m, about 15-20 mN/m, or about 20-25 mN/m.

Any suitable high surface energy polymer may be used in the composite, such as a polyalkylsiloxane, a polycarbonate (PC, [34.2 mN/m at 20° C.]) a polymethylmethacrylate (PMMA, [41.1 mN/m at 20° C.]), a polystyrene (PS, [40.7 mN/m at 20° C.]), a polyvinylidene fluoride (PVDF, [30.3 mN/m at 20° C.]), a polyvinyl fluoride (PVF, [36.7 mN/m at 20° C.]), a polyisobutylene (PIB, [33.6 mN/m at 20° C.]), a polypropylene-isotactic (PP, [30.1 mN/m at 20° C.]), a Polyethylene-linear (PE, [35.7 mN/m at 20° C.]), a polyethylene-branched (PE, [35.3 mN/m at 20° C.]), a polyvinylchloride (PVC, [41.5 mN/m at 20° C.]), a polyvinylacetate (PVA, [36.5 mN/m at 20° C.]), a polynnethylacrylate (PMAA, [41.0 mN/m at 20° C.]), a polyethylacrylate (PEA, [41.1 mN/m at 20° C.]), a polyethylnnethacraylate (PEMA, [35.9 mN/m at 20° C.]), a polybutylmethacraylate (PBMA, [31.9 mN/m at 20° C.]) a polyisobutylmethacraylate (PIBMA, [30.9 mN/m at 20° C.]), a poly(t-butylnnethacrylate) (PtBMA, [30.4 mN/m at 20° C.]), a polyhexylmethacrylate (PHMA, [30.0 mN/m at 20° C.]), a polytetrannethylene oxide (PTME, [31.9 mN/m at 20° C.]) a polyalkylene, etc. In some embodiments, one of the polymers comprises polydimethylsiloxane. In some embodiments, one of the polymers comprises a polycarbonate. In some embodiments, one of the polymers comprises a polystyrene.

In some embodiments, the high surface energy polymer can comprise a thermoplastic polymer. In some embodiments, the thermoplastic polymer can comprise a polycarbonate. In some embodiments, the thermoplastic polymer can comprise a polystyrene.

In some embodiments, the high surface energy polymer has a surface energy of about 30-45 mN/m, about 30-31 mN/m, about 31-32 mN/m, about 32-33 mN/m, about 33-34 mN/m, about 34-35 mN/m, about 35-36 mN/m, about 36-37 mN/m, about 37-38 mN/m, about 38-39 mN/m, about 39-40 mN/m, about 40-41 mN/m, about 41-42 mN/m, about 42-43 mN/m, about 43-44 mN/m, about 44-45 mN/m, about 30-33 mN/m, about 33-36 mN/m, about 36-39 mN/m, about 39-42 mN/m, about 42-45 mN/m, about 30-35 mN/m, about 35-40 mN/m, or about 40-45 mN/m.

In some embodiments, the difference in surface energy between the high surface energy polymer and the low surface energy polymer is at least about 5 mN/m, at least about 10 mN/m, at least about 15 mN/m, at least about 20 mN/m, at least about 25 mN/m, about 4-6 mN/m, about 6-8 mN/m, about 8-10 mN/m, about 10-12 mN/m, about 12-14 mN/m, about 14-16 mN/m, about 16-18 mN/m, about 18-20 mN/m, about 20-22 mN/m, about 22-24 mN/m, about 24-26 mN/m, about 26-28 mN/m, about 28-30 mN/m, about 5-10 mN/m, about 10-15 mN/m, about 15-20 mN/m, about 20-25 mN/m, about 25-30 mN/m, about 5-15 mN/m, about 15-25 mN/m, or about 4-30 mN/m.

In some embodiments, the first polymer and the second hydrophobic polymer can be a combination or mixture of polycarbonate and polydimethylsiloxane. In these embodiments, the weight ratio of polydimethylsiloxane to polycarbonate can be in a range from about 0.1-2 (1 g of polydimethylsiloxane and 10 g of polycarbonate is a mass ratio of 0.1), about 0.1-0.2, about 0.2-0.3, about 0.3-0.4, about 0.4-0.5, about 0.5-0.6, about 0.6-0.7, about 0.3-0.5, about 0.6-0.8, about 0.7-0.9, about 0.8-1, about 0.3-1, about 0.6-1.2, about 1-1.4, about 1.2-1.6, about 1.4-1.8, about 1.6-2, about 1-2, about 0.1-1, about 0.17, about 0.32, about 0.41, about 0.5, about 0.65, about 0.85, about 1, or any weight ratio in a range bounded by any of these values.

In some embodiments, the first polymer and the second hydrophobic polymer can be a combination or mixture of polystyrene and polydimethylsiloxane. In these embodiments, the weight ratio of polydimethylsiloxane to polystyrene can be in a range from about 0.1-2 (1 g of polydimethylsiloxane and 10 g of polystryrene is a mass ratio of 0.1), about 0.1-0.2, about 0.2-0.3, about 0.3-0.4, about 0.4-0.5, about 0.5-0.6, about 0.6-0.7, about 0.3-0.5, about 0.6-0.8, about 0.7-0.9, about 0.8-1, about 0.3-1, about 0.6-1.2, about 1-1.4, about 1.2-1.6, about 1.4-1.8, about 1.6-2, about 1-2, about 0.1-1, about 0.29, about 0.32, about 0.41, about 0.5, about 0.54, about 0.64, about 1, or any weight ratio in a range bounded by any of these values.

In some embodiments, the polyalkylsiloxane, such as polydimethylsiloxane, can be about 2-40 wt %, about 2-5 wt %, about 4-7 wt %, about 6-9 wt %, about 8-11 wt %, about 10-13 wt %, about 12-15 wt %, about 14-17 wt %, about 16-19 wt %, about 18-21 wt %, about 20-23 wt %, about 10-20 wt %, about 22-25 wt %, about 24-27 wt %, about 26-29 wt %, about 28-31 wt %, about 20-30 wt %, about 2-30 wt %, about 30-40 wt %, about 6 wt %, about 11 wt %, about 12 wt %, about 13 wt %, about 15 wt %, about 16 wt %, about 17 wt %, about 19 wt %, about 20 wt %, or any wt % of the total composite in a range bounded by any of these values.

In some embodiments, the polycarbonate can be about 5-70 wt %, about 5-10 wt %, 10-20 wt %, about 20-30 wt %, 20-26 wt %, 24-30 wt %, 20-25 wt %, 25-30 wt %, about 9-14 wt %, about 12-17 wt %, about 15-20 wt %, about 18-23 wt %, about 20-23 wt %, about 22-25 wt %, about 24-27 wt %, about 26-29 wt %, about 28-31 wt %, about 30-33 wt %, about 30-35 wt %, about 33-38 wt %, about 36-41 wt %, about 39-44 wt %, about 42-47 wt %, about 45-50 wt %, about 48-53 wt %, about 5-30 wt %, about 30-40 wt %, about 40-50 wt %, about 50-60 wt %, about 30-60 wt %, or about 60-70 wt % of the total composite, or any wt % in a range bounded by any of these values. Of particular interest are ranges that encompass one or more of the following weight percentages: about 17 wt %, about 20 wt %, about 29 wt %, about 30 wt %, about 32 wt %, about 34 wt %, or about 36 wt %.

In some embodiments, the polymer matrix may contain polystyrene in any suitable amount, such as about 5-70 wt %, about 5-10 wt %, 10-20 wt %, about 20-30 wt %, 20-26 wt %, 24-30 wt %, 20-25 wt %, 25-30 wt %, about 9-14 wt %, about 12-17 wt %, about 15-20 wt %, about 18-23 wt %, about 20-23 wt %, about 22-25 wt %, about 24-27 wt %, about 26-29 wt %, about 28-31 wt %, about 30-33 wt %, about 30-35 wt %, about 33-38 wt %, about 36-41 wt %, about 39-44 wt %, about 42-47 wt %, about 45-50 wt %, about 48-53 wt %, about 5-30 wt %, about 30-40 wt %, about 40-50 wt %, about 50-60 wt %, about 30-60 wt %, or about 60-70 wt % of the total composite, or any wt % in a range bounded by any of these values. Of particular interest are ranges that encompass one or more of the following weight percentages: about 31 wt %, about 32 wt %, about 34 wt %, about 35 wt %, about 36.5 wt % or about 38.5 wt %.

In some embodiments, the polymer matrix may contain poly n-butylmethacrylate in any suitable amount, such as about 1-50 wt %, 10-50 wt %, 25-40 wt %, about 24-29 wt %, about 27-32 wt %, about 30-35 wt %, about 33-38 wt %, about 36-41 wt %, or about 39-44 wt % of the total composite, or any wt % in a range bounded by any of these values. Of particular interest are ranges that encompass one or more of the following weight percentages: about 29 wt %, about 31 wt %, about 35 wt %, about 38 wt %, and about 41 wt %.

Microspheres

The composite can comprise a plurality of microspheres. The microspheres may be dispersed within the polymer matrix. In some cases, the microspheres protrude through the outer surface of the polymer matrix. In some embodiments, the microspheres can comprise a hybrid material. In some embodiments, the hybrid microspheres can self-assemble. In some embodiments, the microspheres comprise a core and a coating. In some embodiments, the microsphere's core can comprise a high surface energy polymer. In some embodiments, the core can comprise a hydrophilic nanoparticle.

In some embodiments, the microsphere core can comprise organic materials. In some embodiments, the organic component can comprise the aforementioned high surface energy polymer. In some embodiments, the high surface energy polymer can comprise a thermoplastic polymer. In some embodiments, the thermoplastic polymer can comprise a polycarbonate. In other embodiments, the thermoplastic polymer can be a polystyrene. In some embodiments, the low surface energy polymer can comprise a polysiloxane. In some embodiments, the polysiloxane can comprise a polydimethylsiloxane.

In other embodiments, the microsphere core can comprise organic materials and inorganic materials. In some embodiments, the inorganic materials can be hydrophilic nanoparticles. In some embodiments, the hydrophilic nanoparticles can comprise a phyllosilicate nanoclay. In some embodiments, the phyllosilicate nanoclay can be selected from the phyllosilicate clay minerals group. In some embodiments, the phyllosilicate nanoclay can comprise an aluminum silicate compound. In other embodiments, the phyllosilicate nanoclay comprises a magnesium aluminum silicate compound.

In some embodiments, the microspheres can comprise a coating. In some embodiments, the microsphere coating can comprise hydrophobic nanoparticles. In some embodiments, the hydrophobic nanoparticles encapsulate a portion of the circumferential surface of the core. In some embodiments, the hydrophobic nanoparticles can comprise hydrophobized hydrophilic materials. In some embodiments, the hydrophobized materials can comprise a perfluoroalkyl modified metal silicate. In some embodiments, the metal silicates can comprise an aluminum silicate, aluminosilicate, aluminum magnesium silicate, or magnesium silicate. In some embodiments, the metal silicate can be a perfluoroalkyl modified halloysite material. In some embodiments, the hydrophobized materials can comprise a perfluoroalkyl modified halloysite. In some embodiments, the hydrophobic nanoparticles do not compatibilize with the first polymer. In some embodiments, the nanoparticles are immiscible or insoluble within the first polymer. In some embodiments at least a portion of the microspheres are disposed only partially within the matrix. In some embodiments the coating can comprise an adherence facilitator.

It is believed that the high surface energy and the low surface energy polymers are incompatible and this incompatibility is due to sufficiently different surface energies which can create self-assembled microspheres within the matrix. It is further believed that the addition of hydrophilic nanoparticles enhances the ability to form self-assembling microspheres within the polymer matrix. The enhanced ability is believed to be due to an agglomeration of the hydrophilic nanoparticles in the presence of the high surface energy polymer to form a hydrophilic core. FIG. 1 is a diagram of a cross section of a microsphere with and without a hydrophilic core. In some embodiments, hydrophilic nanoparticles, such as nanoparticle 12, can be embedded within the high surface energy polymer, such as polymer 11, forming a hydrophilic core, and have a hydrophobic nanoparticle coating, such as coating 10. This agglomeration of hydrophilic nanoparticles is believed to be caused by the high surface energy of the polymer, which draws the hydrophilic nanoparticles into a core or seed. It is believed that the core of hydrophilic nanoparticles helps reduce the surface tension of the high surface energy polymer. In some embodiments, a self-assembling core of polymer and hydrophilic nanoparticles form the core of the microsphere. When no hydrophilic nanoparticles are present, it is believed that the incompatibilities between the high surface energy polymer and the low surface energy polymer create a high energy polymeric core surrounded by the low surface energy polymer. The coating of the high surface energy polymer by the low surface energy polymer is believed to help reduce the surface tension of the high surface energy core.

The microspheres may have any size associated with a spherical or ovoidal shape. For example, a microsphere may have a size, average size, or median size such as a radius or diameter of the sphere that is about 0.1 μm to about 100 μm, about 0.1-0.5 μm, about 0.5-1 μm, about 1-10 μm, about 10-20 μm, about 20-30 μm, about 30-40 μm, about 40-50 μm, about 50-60 μm, about 60-70 μm, about 70-80 μm, about 80-90 μm, about 90-100 μm, about 30-70 μm, about 35-40 μm, about 40-45 μm, about 45-50 μm, about 50-55 μm, about 55-60 μm, about 60-65 μm, about 65-70 μm, or any size such as a radius, a diameter, in a range bounded by any of these ranges.

As used herein, the terms “radius” or “diameter” can be applied to microspheres that are not spherical or cylindrical. For an elongated microsphere, where the aspect ratio of the ratio or length to width is important, the “radius” or “diameter” is the radius or diameter of a cylinder having the same length and volume as the microsphere. For non-elongated microspheres, the “radius” or “diameter” is the radius or diameter of a sphere having the same volume as the microsphere.

In some embodiments, the microspheres can comprise a plurality of hydrophobic nanoparticles disposed upon the microsphere core surface. In some embodiments, the hydrophobic nanoparticles can encapsulate a portion of the circumferential surface of the microsphere core. In some embodiments, at least some of the hydrophobic particles extend outward from the surface of the microsphere. In some embodiments, the plurality of microspheres can define cavities therebetween. In some embodiments, a portion of the hydrophobic encapsulated microspheres dispersed within the surface of the matrix can form a micro/nano rough coating on the matrix surface.

Hydrophilic Nanoparticles

Some embodiments include a hydrophilic nanoparticle material. The hydrophilic nanoparticle can comprise a phyllosilicate nanoclay. In some embodiments the phyllosilicate nanoclay can be selected from the phyllosilicate clay minerals group. The phyllosilicate nanoclay can comprise an aluminum silicate or a magnesium aluminum silicate material. In some embodiments, the aluminum silicate or magnesium aluminum silicate material can be in the shape of nanorods, nanowires, nanofibers, nanotubes and/or combinations thereof. The aluminum silicate and magnesium aluminum silicate can be a commercial product, such as Halloysite (Millipore-Sigma, St. Louis, Mo., USA) and/or Attapulgite (ATP 95%, Gelest Inc., Morrisville, Pa. USA).

In some embodiments, the phyllosilicate nanoclay is present as nanorods. A nanorod may be an elongated nanoparticle. In some embodiments, the hydrophilic nanorods can comprise an aluminum silicate (halloysite, Ai₂Si₂O₅(OH)₄). Other embodiments include nanorods that can comprise a magnesium aluminum silicate, (attapulgite, (Mg,Al)₂Si₄O₁₀(OH).4H₂O).

In some embodiments, the nanorods can have a length of about 1 μm to about 3 μm and a width or diameter of about 30 nm to about 70 nm. It is believed that the phyllosilicate compound may have an aspect ratio (i.e., length/width or length/diameter) of about 5-100, about 5-10, about 5-25, about 10-30, about 15-35, about 20-40, about 25-45, about 30-50, about 35-55, about 40-60, about 45-65, about 50-70, about 55-75, about 60-80, about 65-85, about 70-90, about 75-95, about 80-100, or any aspect ratio in a range bounded by any of these values.

In some embodiments, the hydrophilic nanoparticle nanorods, may be about 0-50 wt %, about 0.1-23 wt %, about 0-13 wt %, about 5-15 wt %, about 10-17 wt %, about 15-19 wt %, about 18-21 wt %, about 20-23 wt %, about 22-25 wt %, about 24-27 wt %, about 26-29 wt %, about 28-30 wt %, about 20-30 wt %, about 22-30 wt %, about 30-40 wt %, or about 40-50 wt % of the total weight of the composite, or any weight percentage in a range bounded by any of these values. Of particular interest are any of the above ranges that encompass one or more of the following weight percentages: about 11 wt %, about 12 wt %, about 13 wt %, about 14 wt %, about 15 wt %, about 17 wt %, about 22 wt %, about 26 wt %, about 27 wt %, and about 29 wt %.

In some embodiments, the nanorods can have a concentrated distribution within the composite. The distribution of the nanorods in turn is thought to result in a composite having exposed surfaces that define a nano-structure roughness with a scale commensurate with the dimensions of the nanorods; even after abrasion of the initial surface. It is further thought that the nanostructure-scale roughness when combined with the hydrophobic character of the other materials in the composite result in a hydrophobic, superhydrophobic, and/or snowphobic composite that retains its hydrophobicity, superhydrophobicity, and/or snowphobicity even after the initial surface is eroded away.

In some embodiments, the composite can comprise a hydrophobized hydrophilic material. In some embodiments, the hydrophobized hydrophilic material can be a fluorinated metal silicate.

Hydrophobic Nanoparticles

In some embodiments, the composite can comprise hydrophobic nanoparticles. The hydrophobic nanoparticles can coat and encapsulate the microsphere core, creating a substantial hydrophobic outer surface. Some embodiments the hydrophobic nanoparticles can comprise a modified phyllosilicate nanoclay. In some embodiments, the hydrophobic nanoparticles can comprise modified metal silicates. In some embodiments, the hydrophobic nanoparticles can comprise fluorinated metal silicates. In some embodiments, the modified metal silicates can be modified aluminum silicate, modified magnesium aluminum silicate magnesium silicate and/or modified aluminosilicate. The term aluminosilicate refers to a silicate in which a proportion of the Si⁴⁺ ions are replaced by Al³⁺. In some embodiments, the excess negative charge may be balanced by sodium, potassium or calcium ions. In some embodiments, the hydrophobic nanoparticle can comprise a fluorinated material. In some embodiments, the hydrophobic nanoparticle can comprise a fluorinated metal silicate. In some embodiments, the fluorinated metal silicates can be a fluorinated aluminum silicate, fluorinated magnesium aluminum silicate magnesium silicate and/or fluorinated aluminosilicate. In some embodiments, the nanoparticle can be in the shape of a nanorod, a nanowire, a nanofiber, a nanotube and/or combinations thereof. In some embodiments, the hydrophobic nanoparticle comprises a fluorinated phyllosilicate nanorod.

In some embodiments, the hydrophobic nanoparticle is about 20-80 wt %, about 20-50 wt %, about 50-80 wt %, about 20-40 wt %, about 40-60 wt %, about 60-80 wt %, about 20-30 wt %, about 30-40 wt %, about 40-50 wt %, about 50-60 wt %, about 60-70 wt %, about 70-80 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, or 75-80 wt %, of the total weight of the composite, or any weight percentage in a range bounded by any of these values.

In some embodiments, the modified phyllosilicate nanorod can comprise a modified aluminum silicate. In other embodiments, the modified aluminum silicate can be a halloysite nanorod, an attapulgite nanorod and/or combinations thereof. In some embodiments, the phyllosilicate nanoclay can be modified by perfluorinated compounds. For example, a polyfluoroalkyl molecule, such as trichloro(1H,1H,2H,2H-perfluorooctyl)silane can modify the surfaces of a phyllosilicate nanorod by chemical bonds so as to improve the hydrophobicity of the phyllosilicate nanorod surface. It is thought that surface modification of the phyllosilicate nanorod can make it more hydrophobic than a non-modified phyllosilicate nanorod. The reaction is represented below:

[chemical structure]

In some embodiments, the hydrophobic nanoparticle, in the form of modified phyllosilicate nanorods, can be about 20-70 wt %, about 20-25 wt %, about 25-30 wt %, about 30-40 wt %, about 40-50 wt %, about 50-60 wt %, about 60-70 wt %, about 40-45 wt %, about 45-50 wt %, about 50-55 wt %, about 55-60 wt %, about 43-45 wt %, about 45-49 wt %, about 49-51 wt %, about 51-53 wt %, or about 53-55 wt % of the total weight of the composite, or any weight percentage in a range bounded by any of these values. Of particular interest are any of the above ranges that encompass one or more of the following weight percentages: about 41 wt %, about 44 wt %, about 50 wt %, and about 67 wt %.

In some embodiments, the hydrophobic nanoparticle, in the form of modified attapulgite, can be about 6-8 wt %, about 8-10 wt %, about 10-12 wt %, about 14-16 wt %, about 16-18 wt %, about 18-20 wt %, about 20-22 wt %, about 22-24 wt %, about 24-26 wt %, about 26-28 wt %, about 28-30 wt %, about 5-10 wt %, about 10-15 wt %, about 15-20 wt %, about 20-25 wt %, about 25-30 wt %, about 5-15 wt %, about 15-25 wt %, or about 20-30 wt % of the total weight of the composite, or any weight percentage in a range bounded by any of these values. Of particular interest are any of the above ranges that encompass one or more of the following weight percentages: about 41 wt %.

In some embodiments, the hydrophobic nanoparticle, in the form of modified halloysite, can be 20-70 wt %, about 20-30 wt %, about 30-40 wt %, about 40-50 wt %, about 50-60 wt %, about 60-70 wt %, about 40-45 wt %, about 45-50 wt %, about 50-55 wt %, about 55-60 wt %, about 60-65 wt %, about 65-70 wt %, about 70-75 wt %, about 75-80 wt %, about 39-41 wt %, about 41-43 wt %, about 43-45 wt %, about 45-47 wt %, about 47-49 wt %, about 49-51 wt %, about 51-53 wt %, about 53-55 wt %, about 55-57 wt %, about 57-59 wt %, about 59-61 wt %, about 61-63 wt %, about 63-65 wt %, about 65-67 wt %, about 67-69 wt %, about 69-71 wt %, about 71-73 wt %, or about 73-75 wt % of the total weight of the composite, or any weight percentage in a range bounded by any of these values. Of particular interest are any of the above ranges that encompass one or more of the following weight percentages: about 41 wt %, about 44 wt %, about 50 wt %, or about 67 wt %.

Silica nanoparticles may potentially be useful. A silica nanoparticle may be any nanoparticle that comprises silica or silicon dioxide, such as a SiO₂ particle, e.g. a sphere. The nanoparticles may be essentially pure silica nanoparticles, or may contain at least about 0.1 wt %, at least about 10 wt %, at least about 20 wt %, at least about 30 wt %, at least about 40 wt %, at least about 50 wt %, at least about 60 wt %, at least about 70 wt %, at least about 80 wt %, at least about 90, about 0.1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt % silicon dioxide or silica.

In some embodiments, the silica nanoparticles can be modified, e.g. chemically modified. For example, the organosiloxane compound can modify the surfaces of the silica nanoparticle by chemical bonds (such as chemical bonds generated by hydrolysis) so as to improve the hydrophobicity of the surfaces of the silica nanoparticles. In other embodiments, the modified silica nanoparticles can be commercial products such as Silicon Oxide Nanoparticles/Nanopowder treated with Silane Coupling Agents SiO₂ 99% (SkySpring Nanomaterials, Inc. Houston Tex., USA).

The silica nanoparticles can be fabricated by sol-gel method, vapor reaction method, hydro-thermal method, deposition method, physical crumbling method mechanical ball polishing method, chemical vapor deposition method, micro-emulsion method, electro-chemistry method, or any method known in the art.

A silica nanoparticle may have any size associated with a nanoparticle. For example, a silica nanoparticle may have a size, average size, or median size, such as a radius or a diameter, of the particle that is about 10-500 nm, about 10-100 nm, about 100-200 nm, about 200-300 nm, about 300-400 nm, about 10-30 nm, about 20 nm, about 10-20 nm, about 20-30 nm, about 30-40 nm, about 40-50 nm, about 50-60 nm, about 60-70 nm, about 70-80 nm, about 80-90 nm, about 90-100 nm, about 100-110 nm, about 110-150 nm, about 150-250 nm, about 250-350 nm, about 350-450 nm, about 400-500 nm, or any size, such as a radius, a diameter, in a range bounded by any of these values.

Any suitable amount of the silica nanoparticle may be used. In some embodiments, the silica nanoparticle may (e.g. SiO₂ nanoparticles) be about 10-60 wt %, about 10-20 wt %, about 20-30 wt %, about 30-40 wt %, about 40-50 wt %, about 50-60 wt %, about 25-30 wt %, about 35-42 wt %, about 6-8 wt %, about 8-10 wt %, about 10-12 wt %, about 14-16 wt %, about 16-18 wt %, about 18-20 wt %, about 20-22 wt %, about 22-24 wt %, about 24-26 wt %, about 26-28 wt %, about 28-30 wt %, about 30-32 wt %, about 32-34 wt %, about 34-36 wt %, about 36-38 wt %, about 38-40 wt %, about 40-42 wt %, about 42-44 wt %, about 44-46 wt %, about 46-48 wt %, or about 48-50 wt %, of the composite, or any weight percentage in a range bounded by any of these values. Of particular interest are any of the above ranges that encompass one or more of the following weight percentages: about 26 wt %, about 27 wt %, about 29 wt %, about 35 wt %, about 36.5 wt %, about 37 wt %, about 38.5 wt %, and about 39 wt %,

Micro/Nano Rough Surface

In some embodiments, the high surface energy polymer and the low surface energy polymer can be combined or mixed to form a polymer matrix, e.g., polymer matrix 212, as shown in FIG. 2. In some embodiments, a substantial amount of the hydrophobic coated microspheres, such as microspheres 230 and 330, as shown in FIG. 2 and FIG. 3, can be dispersed within the polymer matrix. In some embodiments, a sufficient amount of the hydrophobic coated microspheres can partially protrude through the surface of the polymer matrix creating a micro/nano roughness thereon. The composite can also contain other components, such as particle additives.

In some embodiments, hydrophobic coated microspheres can have a substantially uniform distribution within the composite. The distribution of hydrophobic coated microspheres in turn is thought to result in a coating having exposed surfaces that define a micro/nano roughness with a scale commensurate with the dimensions of the microspheres and the nanorods. It is further thought that the microspheres distribution creates defined cavities, such as cavities 440 (see FIG. 4), between and among the plurality of hydrophobic coated microspheres that protrude through the surface of the polymer matrix. It is further believed that these defined cavities are, to a substantial extent, reduced due to the ability of the nanorods (such as nanorods 210 and 310 in FIG. 2 and FIG. 3) to reinforce the coating's polymeric matrix through their networking with one another, resulting in reduced cracking in the coating during curing. It is further believed that resulting reduction in the size of the defined cavities results in a crack free surface, which in turn results in significant improvements in the snow sliding performance of the composite coating. It is believed that decreasing the area of the defined cavities and the cracks within the surface of the coating increases dry snow sliding while still maintaining the overall water contact angle of the coating. The increase in dry snow sliding from the coating is a significant improvement over currently available anti-snow/anti-icing coatings. This increase in the dry snow sliding is believed to be due to the inability of dry snow to accumulate within the air gaps/pockets or surface cracks.

The micro roughness may have any size associated with a microsphere/microparticle. The microsphere can comprise any suitable material, for example but not limited to, self-assembled microspheres with an organic material core, self-assembled microsphere with an organic inorganic core, silica beads, etc. The microsphere may have a size, average size, or median size such as a radius or a diameter, of the particle that is about 1 μm to about 10 μm, about 1-2 μm, about 2-3 μm, about 3-4 μm, about 4-5 μm, about 5-6 μm, about 6-7 μm, about 7-8 μm, about 8-9 μm, about 9-10 μm, about 2.5-5.5 μm, about 7.5-10 μm, or any size, such as a radius, a diameter, in a range bounded by any of these values.

The nano roughness may have any size associated with a nanoparticle. The nanoparticle can comprise any suitable materials, for example but not limited to a nanorod, nanowire, nanotube, nanofiber, etc. The nanoparticle may have a size, average size, or median size such as a radius or diameter, of the particle that is about 10 nm to about 500 nm, about 10-100 nm, about 100-200 nm, about 200-300 nm, about 300-400 nm, about 400-500 nm, about 10-20 nm, about 10-30 nm, about 20-30 nm, about 30-40 nm, about 40-50 nm, about 50-60 nm, about 60-70 nm, about 70-80 nm, about 80-90 nm, about 90-100 nm, about 100-110 nm, about 110-150 nm, about 150-250 nm, about 250-350 nm, about 350-450 nm, or any size, such as a radius, a diameter, in a range bounded by any of these values.

Some embodiments include a method of preparing a surface coating composite comprising: a) selecting a high surface energy polymer and a low surface energy polymer, wherein the polymers have dissimilar surface energies of at least 50% relative to one another; b) selecting a hydrophilic nanoparticle which when mixed within a high surface energy polymer forms the hydrophilic microspheric cores; c) selecting a hydrophobic nanoparticle which substantially encapsulates the microsphere when mixed together; and d) mixing the high surface energy polymer and the lower surface energy polymer, creating an immiscible polymer solution, wherein the hydrophobic nanoparticle encapsulated microspheres are dispersed therethrough.

Coatings and Preparation Methods

Some embodiments include a method of making a coating. The method can comprise: mixing an amount of a hydrophobic polymer, with a surface energy of up to 22 mJ/m² and a solvent creating a first liquid mixture; mixing hydrophilic nanoparticles into to the first liquid mixture creating a second liquid mixture; adding hydrophobic nanoparticles to the second liquid mixture, mixing for an amount of time to provide a third liquid mixture; mixing a hydrophobic polymer into the third liquid mixture, with a surface energy of at least 30 mJ/m² to create a final liquid mixture; and adding a ceramic milling media to the final liquid mixture, transferring the final liquid mixture with milling media to a ball milling machine and mixing at 160 rpm for at least sixteen hours, creating a coating slurry. In some embodiments the slurry is coated onto a substrate to increase the hydrophobicity or snowphobicity of the surface.

Some embodiments include a process for making a composite with micro/nano rough surface, wherein the process can be according to with the method described above.

In some embodiments, a method of surface treatment can comprise applying the aforedescribed surface coating to a surface to increase the hydrophobicity or snowphobicity of the surface.

A composite may be in the form of a solid layer on a surface where prevention of anti-fouling, ice and/or snow accumulation is required. In some embodiments, the composite is a solid layer with a thickness of about 16-20 μm, about 18-22 μm, about 20-24 μm, about 22-26 μm, about 24-28 μm, about 26-30 μm, about 28-32 μm, about 30-34 μm, about 32-36 μm, about 34-38 μm, about 36-40 μm, about 38-42 μm, about 40-44 μm, about 42-46 μm, about 44-48 μm, about 46-50 μm, about 45-52 μm, about 50-57 μm, about 55-62 μm, about 60-67 μm, about 65-72 μm, about 70-77 μm, about 75-82 μm, about 80-87 μm, about 85-92 μm, about 90-97 μm, about 95-102 μm, about 100-107 μm, about 105-112 μm, about 110-117 μm, about 115-122 μm, about 120-127 μm, or about 125-132 μm, or any thickness in a range bounded by any of these values. Of particular interest are any of the above ranges that encompass one or more of the following thicknesses: about 22 μm, about 23 μm, about 27 μm, about 30 μm, about 33 μm, about 35 μm, about 46 μm, about 79 μm, and about 106 μm.

A composite may be used in a surface treatment for repelling ice, water, or snow from a surface. The method can comprise treating a surface with a mixture comprising a first hydrophobic polymer, second hydrophobic polymer, a hydrophobic nanoparticle, and a hydrophilic nanoparticle.

For treating a surface, the composite may be mixed in a solvent to form a coating mixture. Such a mixture can comprise the requisite amounts of hydrophobic polymer(s), hydrophobic nanoparticle, hydrophilic nanoparticle and a solvent, such as toluene, tetrachloroethane, acetone or any combination thereof. In some embodiments, the treatment comprises: (1) mixing hydrophobic polymer(s), a hydrophobic nanoparticle, and a hydrophilic nanoparticle with a solvent to form a coating, (2) applying the mixture on the untreated surface, and (3) curing the coating by heating the coating to a temperature between 80° C. to about 120° C. for 3 hours to about 24 hours, to completely evaporate the solvent.

In some embodiments, the step of treating can also comprise the intermediate steps of drying, crushing, and reconstituting the mixture after mixing but before applying the mixture. It is believed that the intermediate steps will ensure uniform mixing and prevent lumps in the coating. In some the intermediate steps, where the mixture is first suspended in a solvent, the solvent can be evaporated by methods known to those skilled in the art to create a dried powder. In some methods, then the dried powder can be subsequently crushed by methods known in the art, such as a mortar and pestle, to break up any lumps. In some crushing steps, a solvent, such as acetone, may be added to help break up lumps and facilitate a smooth mixture. In some methods the intermediate step of crushing and drying can then comprise drying the smooth mixture at a temperature of about 40° C. to about 100° C., or about 90° C., until completely dry.

In some embodiments, the treating step can also comprise applying the coating mixture on the untreated surface. Applying the coating mixture can be done by any methods such as blade coating, spin coating, dye coating, physical vapor deposition, chemical vapor deposition, spray coating, ink jet coating, roller coating, etc., and methods known by those skilled in the art. In some embodiments, the coating step can be repeated until the desired thickness of coating is achieved. In some methods, applying can be done such that a contiguous layer is formed on the surface to be protected.

In some embodiments, the wet coating of composite may have a thickness of about 1-50 μm, about 10-30 μm, about 20-30 μm, about 50-150 μm, about 100-200 μm, about 150-250 μm, about 200-300 μm, about 260-310 μm, about 280-330 μm, about 300-350 μm, about 320-370 μm, about 340-390 μm, about 360-410 μm, about 380-430 μm, about 400-450 μm, about 420-470 μm, about 400-600 μm, about 500-700 μm, or about 600-800 μm or any thickness in a range bounded by any of these values. Of particular interest are any of the above ranges that encompass one or more of the following thicknesses: about 25 μm, about 300 μm, about 350 μm, about 380 μm, and about 790 μm.

In some embodiments, treating can further comprise curing the coating by heating the coating to a temperature and time sufficient to completely evaporate the solvent. In some embodiments, the step of curing can be done at a temperature of about 40° C. to about 150° C., or about 120° C., for about 30 minutes to 3 hours, or about 1-2 hours, until the solvent is completely evaporated. In some embodiments, a composition by the process described above can be provided. The result can be a treated surface that can be resistant to water, ice and snow even after facing a harsh environment where some of the coating has been eroded.

### EXAMPLES

It has been discovered that embodiments of the composite described herein exhibit bulk performance. These benefits are further demonstrated by the following examples, which are intended to be illustrative of the disclosure, but are not intended to limit the scope or underlying principles in any way.

### Example 1.1

### Preparation of the Hydrophobic Nanorods

In a 500 mL two-neck round bottom flask, 100 g of hexane (98%, VWR International, Radnor, Pa., USA) and 1.12 g of trichloro(1H,1H,2H,2H-perfluorooctyl)silane (97% Millipore-Sigma, Burlington, Mass. USA) are mixed and stirred for 15 minutes. Next, 11.24 g of halloysite nanoclay powder (diameter x length: 30-70 nm×1-3 μm; pore size: 1.26-1.34 mL/g pore volume; surface area: 64 m²/g; Millipore-Sigma, Burlington, Mass. USA) or attupulgite nanoclay powder (95% Attupulgite, Gelest Inc. Morrisville, Pa., USA) were added to the mixture to form a slurry. Anti-mouth rubber stoppers were used to plug the flask's mouths and the slurry was vigorously stirred for 20 hours at room temperature. Additionally, dry nitrogen gas or argon gas was used to purge the moisture from the slurry.

The reaction product mixture was transferred to 50 mL centrifuge tubes and separated by centrifugation at 2,500 rpm for 3 minutes (1,050 RCF, IEC Centra CL2 with a 236 Aerocarrier Rotor, Thermo Electron Corporation, Milford, Mass., USA). The liquid phase was discarded and the solid phase was rinsed with hexane followed and again separated by centrifugation (1,050 RCF for 3 minutes). This rinsing step was repeated for a total of 3 rinses to completely remove the unreacted perfluorooctylsilane starting material. The final solid phase was dried in an oven (Symphony 414004-568 Horizontal Air Flow Convection Oven, VWR International, Radnor, Pa., USA) at 70° C. for 5 hours to remove the solvent completely.

### Example 1.2

### Preparation of Coating Mixture: One Pot Process

Preparation of Coating Slurry: (See Table 1 below for the wt % amounts of the individual materials used.) Polydimethylsiloxane (PDMS) resin (Sylgard 184, Dow Corning, Midland, Mich., USA) was dissolved in 15 mL toluene (anhydrous, 99.8%, Sigma-Aldrich) in a 20 mL glass vial with stirring using a stir bar. Hydrophilic attapulgite nanoparticles (95%, Gelest, Inc.) or halloysite (Sigma-Aldrich) was added to the mixture and stirred. Next, hydrophobic nanoparticles comprising fluoroalkyl-treated halloysite (Sigma-Aldrich), fluoroalkyl-treated attapulgite (95%, Gelest Inc.) or silane modified silicon dioxide nanoparticles (Skyspring Nanomaterials Inc.), were added to the mixture. The resulting mixture was then stirred vigorously for at least 1 hr. The second polymer, comprising polycarbonate or polystyrene, was then added to the mixture. The stir bar was replaced with sphere-shape Yttrium-Stabilized Zirconia ceramic milling media (diameter 5 mm) and the 20 mL glass vial containing the mixture was transferred to a ball milling machine (Model MF-4, ITO Seisakusho, Japan) to mix at 160 rpm for at least 16 hours to generate a slurry for casting. Table 1 shows experimental composites, in wt %.

TABLE 1

| | Hydrophobic | | Hydrophilic | | | | | | |
|---|---|---|---|---|---|---|---|---|---|
| | Nanoparticle | | Nanoparticle | | First Polymer | | Second Polymer | | Solvent |
| Composite | Material | wt % | Material | wt % | Material | wt % | Material | wt % | Material |
| GP-1 | m-SiO₂ | 29 | ATP | 29 | PDMS | 6 | PC | 36 | Toluene |
| GP-2 | m-SiO₂ | 27.4 | ATP | 27.4 | PDMS | 11 | PC | 34.2 | Toluene |
| GP-3 | m-SiO₂ | 26 | ATP | 26 | PDMS | 16 | PC | 32 | Toluene |
| GP-4 | m-SiO₂ | 44 | HS | 15 | PDMS | 12 | PC | 29 | Toluene |
| GP-5 | m-SiO₂ | 41 | HS | 14 | PDMS | 11 | PC | 34 | Toluene |
| GP-6 | m-SiO₂ | 38.5 | HS | 12.8 | PDMS | 10.2 | PC | 38.5 | Toluene |

| | |
|---|---|
| Pseudo- | Pseudoboehmite by acid etching aluminum |
| boehmite | |
| CE-1 | HIREC 100 |
| CE-2 | HIREC 450 |

*m-SiO₂: Silane Modified Silicon Dioxide; ATP: Attapulgite Nanoclay; HS: Halloysite; PDMS: Polydimethlysiloxane; PC: Polycarbonate

### Example 2

### Preparation of a Superhydrophobic Coating Element

Coating Application. The slurry was cast on a PET film (7.5 cm×30 cm) with a Casting Knife Film applicator (Microm II Film Applicator, Paul N. Gardner Company, Inc.) at a cast rate of 10 cm/s. The blade gap on the film applicator was set at about 5 mils for a final wet coating thickness of about 127 μm. For applications wider than about 2 inches/5.1 cm, an adjustable film applicator (AP-B5351, Paul N. Gardner Company, Inc., Pompano Beach, Fla., USA) was alternatively used.

Drying: The PET was pre-heated to about 40° C. on the vacuum bed of the compact tape casting coater (MSK-AFA-III, MTI Corporation, Richmond, Calif., USA) to increase the solvent evaporation rate. The coating was then dried for 1 hour at 100° C. inside an air-circulating oven (105 L Symphony Gravity Convection Oven, VWR) until completely dry, to produce the treated substrate.

### Example 3.1

### Performance Testing of Selected Elements

Preparation of Ice Powder: Ice blocks (−30° C. to −20° C.) were shaved with a shaved ice maker (Doshisha Model DCSP-1751 Ice Shaver, Doshisha Corporation Ltd., Tokyo, Japan) in a chest freezer (Kelvinator Commercial Chest Freezer Model KCCF160QWA, Electrolux Professional Inc., Charlotte, NC, USA). The shaved ice was then passed through an 8-inch sieve (#18 VWR® 8″ Test Sieve, VWR International, L.L.C., Radnor, Pa., USA) with a 1 mm opening. The resulting ice powder was stored in the chest freezer until use.

Snow Fall Test: Sample plates (11.5 cm width×14 cm length) were coated with a test coating (coating area: 10 cm width×14 cm length) were taped in place on a cold plate heat sink (Ohmite Model CP4A-114A-108E, Ohmite Holding, L.L.C. /Warrenville, Ill., USA). The cold plate heat sink was in turn mounted on an adjustable angle mount (Thorlabs Model AP 180, Thorlabs Company, Newton N.J., USA) to form a test cell with the cold plate heat sink's temperature controlled by a chiller (Coherent Model T255P, Coherent, Inc. Santa Clara, Calif., USA), with the temperature being slightly above 0° C. (e.g., 0.2° C.). The test cell was placed in a freezer/refrigerator (Excellence Industries model HB-6HCD, Excellence Industries, Tampa Fla., USA), and all experiments were carried out within the freezer/refrigerator, with the sample temperature about 0° C. ±1° C..

The ice powder fell through a duct with a diameter of about 7.5 cm. Water content of the fallen ice powder was controlled by the amount of duct that exposed above the freezer/refrigerator, exposing the ice powder to ambient room temperature for a portion of its free fall (ambient temperature is about 20° C.). Specifically, for this experiment water content of the ice powder was held to 10 wt %. With the test cell placed immediately below the duct, the incline angle was adjusted to either 60 degrees, 45 degrees, or 30 degrees. The ice powder was then taken from the freezer/refrigerator and was dumped from the top of the duct using a sieve for the sifter. Since the diameter of the duct was smaller (7.5 cm) than the total area of the sample plates width (11.5 cm), the ice powder was dumped only onto the coated portion of the sample plate, avoiding strong ice powder adhesion to non-coated areas of the sample plate. The bottom of the sample was also slightly rolled to the backside of the cold plate to prevent ice powder accumulation at the coating edge. Snow accretion or sliding from the sample coating was then recorded by a digital video camera. The data was evaluated and scaled, the scaled evaluation of the snow accumulation was based on the average weight or area covered by the frequency (time) of snow accumulation at the respective test angles. In some embodiments, the composite provides a snow fall test score of 5 or better. A score of 5 is equivalent to no snow adhesion, snow keeps sliding off the test area. In some embodiments, the composite provides a snow fall test score of 4 or better. A score of 4 is equivalent to snow crystals adhering to the surface but sliding off the surface after about every 10 seconds of accumulation with an average coverage area of about 20%. In some embodiments, the composite provides a snow fall test score of 3 or better. A score of 3 is equivalent to snow crystals adhering to the surface with snow sliding off after about every 30 seconds to 1 minute of accumulation. In some embodiments, the composite provides a snow fall test score of 2 or better. A score of 2 is equivalent to the average snow accumulation on more than 80% of the test area with snow sliding after every 3-5 minutes of accumulation. In some embodiments, the composite provides a snow fall test score of 2 or better. A score of 1 indicates that the snow does not slide off the test surface. Results for different coatings appear in Table 2 below.

Snow Sliding Angle Testing: Samples were secured into place on the test cell as previously described. A mask with a 2.5 cm diameter opening was placed on top of the sample in the test cell. The masked area of the test sample was partially filled in (approximately 1-3 mm, about 0.05 to about 0.1 g) using the sieve to make an ice powder pellet. The mask was carefully removed and a metal plate (copper or aluminum) with a 2.5 cm diameter and of differing weight (0.67 g to 10 g) were placed on top of the ice powder pellet. To measure the incline angle of the test cell, a digital bevel box gauge angle protractor (Gain Express model AG-0200BB, Gain Express Holdings, Ltd., Kowloon, Hong Kong) was place on the test cell to measure the incline angle. The incline angle of the test cell was then gradually increased manually until the metal plate covered ice pellet started to slide, see FIG. 5 for a representation of the test. The value was recorded as the sliding angle at the weight (a[deg]). The sliding angle vs. weight (weight of the metal plate) were fitted using the following formula:

$$sin α - {μ}_{s} cos α = \frac{{f}_{0}}{m g} S$$

where μₛ=static friction coefficient between the ice powder pellet and the sample surface [−], f₀=shear adhesion strength between the ice pellet and the sample surface [Nm⁻²], m=mass of the metal plate [kg], g=gravity [ms²], and S=the nominal area of contact between the ice powder pellet and the sample surface [m²]. The results are presented in Table 2.

TABLE 2

| | Snow Sliding Angle | | Snow Fall Test | | |
|---|---|---|---|---|---|
| Composite | μ₂ | f₀ | 60° | 45° | 30° |
| GP-1 | 0.5 | 0.2 | 1 | 1 | 1 |
| GP-2 | 0.66 | 0.05 | 4.5 | 1 | 1 |
| GP-3 | 0.59 | 0.3 | 4.5 | 2.5 | 1 |
| GP-4 | 0.62 | 0.35 | | | |
| GP-5 | 0.76 | 0.26 | | | |
| GP-6 | 0.59 | 0.51 | | | |
| Pseudoboehmite | 1.2 | 0.35 | | | |
| CE-1 (HIREC 100) | 1.57 | 0.12 | 4.8 | 1 | 0 |
| CE-1 (HIREC 450) | 1.0 | 0.47 | | | |

The results show at least GP-2 and GP-3 exhibit anti-snow activity at 60° and GP-3 exhibited anti-snow activity at 45°.

Unless otherwise indicated, all numbers expressing quantities of ingredients, properties such as molecular weight, reaction conditions, and etc. used herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sough to be achieved, and should, therefore, be considered as part of the disclosure. At the very least, the examples shown herein are for illustration only, not as an attempt to limit the scope of the disclosure.

The terms “a,” “an,” “the,” and similar referents used in the contest of the describing embodiments of the present disclosure (especially in the context of the following embodiments) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any embodiment. No language in the specification should be construed as indicating any non-embodied elements essential to the practice of the embodiments, of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variation on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

### Embodiments

Embodiment 1 A composite comprising:
a. A polymer matrix, having a first surface, the matrix comprising a high surface energy first polymer and a low surface energy second polymer having sufficiently different surface energies to cause the first and the second polymers to be incompatible within each other; and
b. A plurality of microspheres, the, microspheres comprising core and a hydrophobic coating, wherein the core comprises at least one high surface energy polymer, and wherein the coating comprises a plurality of hydrophobic nanoparticles disposed upon the microspheres circumferential surface, wherein at least some microspheres disperse within the first surface of the matrix.

Embodiment 2 The composite of embodiment 1, wherein at least some of the hydrophobic nanoparticles extend outward from the surface of the microsphere.

Embodiment 3 The composite of embodiment 1, wherein the plurality of microspheres define cavities therebetween.

Embodiment 4 The composite of embodiment 1, further comprising hydrophilic nanoparticles.

Embodiment 5 The composite of embodiment 1, wherein the high surface energy polymer and the hydrophilic nanoparticles form the core of the microspheres.

Embodiment 6 The composite of embodiment 5, wherein the hydrophilic nanoparticles comprise inorganic materials.

Embodiment 7 The composite of embodiment 6, wherein the inorganic materials comprise a phyllosilicate nanoclay.

Embodiment 8 The composite of embodiment 1-7, wherein the hydrophilic nanoparticles and the high surface energy first polymer comprise the hydrophilic core of the microspheres.

Embodiment 9 The composite of embodiment 1, wherein the hydrophobic nanoparticles comprise modified silicon dioxide or silinated inorganic materials.

Embodiment 10 The composite of embodiment 1, wherein the hydrophobic nanoparticles comprise hydrophobized hydrophilic materials.

Embodiment 11 The composite of embodiment 1, wherein the hydrophobized materials comprise a silinated phyllosilicate nanoclay.

Embodiment 12 The composite of embodiment 1, wherein hydrophobic nanoparticles do not compatibilize with the high surface energy first polymer and at least a portion of the microspheres are disposed only partially within the matrix.

Embodiment 13 The composite of embodiment 1, wherein the composite is a coating.

Embodiment 14 The composite of embodiment 1, wherein the first hydrophobic polymer has a surface energy of at least 30γ₅/mJ m⁻².

Embodiment 15 The composite of embodiment 1, wherein the second hydrophobic polymer has a surface energy of up to 22 γ₅/mJ m⁻².

Embodiment 16 The composite of embodiments 1, wherein the high surface energy first polymer comprises a thermoplastic polymer.

Embodiment 17 The composite of embodiments 1, wherein the thermoplastic polymer is polycarbonate.

Embodiment 18 The composite of embodiments 1, wherein the low surface energy second polymer comprises a polysiloxane.

Embodiment 19 The composite of embodiment 1, wherein the polysiloxane comprises polydimethylsiloxane.

Embodiment 20 The composite of embodiment 1, wherein the polymer matrix comprises a combination of polycarbonate and polydimethylsiloxane.

Embodiment 21 The composite of embodiment 1, wherein the microspheres have a radius or a diameter of about 1 μm to about 100 μm.

Embodiment 22 The composite of embodiment 6, wherein the phyllosilicate nanoclay comprises an aluminum silicate, a magnesium aluminum silicate and/or combinations thereof.

Embodiment 23 The composite of embodiment 6, wherein the phyllosilicate nanoclay comprise a nanorod, a nanowire, a nanofiber, a nanotube and/or combinations thereof.

Embodiment 24 The composite of embodiment 25, wherein the phyllosilicate nanoclay comprises a nanorod.

Embodiment 25 The composite of embodiment 26, wherein the nanorod has a length of about 1 μm to about 3 μm and a radius/diameter of about 10 μm to about 100nm.

Embodiment 26 The composite of embodiment 1-27, wherein the composite surface micro roughness of about 0.1 μm to about 50 μm.

Embodiment 27 The composite of embodiments 1-28, wherein the hydrophobic nanoparticles within the coating provide a nano roughness of about 10 μm to about 500 nm.

Embodiment 28 A method for making a coating comprising:
a. Selecting a high surface energy polymer and a low surface energy polymer, wherein the polymers have dissimilar surface energies of at least 50% relative to one another;
b. Selecting a hydrophilic nanoparticle which forms hybrid microspheres when mixed with the high surface energy polymer;
c. Selecting a hydrophobic nanoparticle which substantially encapsulates the hybrid microspheres when mixed together; and
d. mixing the high surface energy polymer and the low surface energy polymer, creating an immiscible polymer solution, wherein the hydrophobic nanoparticle encapsulated hybrid microspheres are dispersed therethrough.

Embodiment 29 The method of embodiment 29, further comprising a solvent.

Embodiment 30 A method of surface treatment comprising applying the composite of embodiment 1 to a surface in need of treatment.

Embodiment 31 A composite with a micro/nano rough surface prepared in accordance with the method of:
a. mixing a hydrophobic polymer with a surface energy up to 22γ₅/mJ m⁻² with a solvent creating a first liquid mixture;
b. adding hydrophilic nanoparticle to the first liquid mixture and mixing, creating a second liquid mixture;
c. adding hydrophobic nanoparticles to the second liquid mixture and mixing, creating a third liquid mixture;
d. adding a hydrophobic polymer with a surface energy of at least 30γ₅/mJ m⁻² to the third liquid mixture and mixing creating a final liquid mixture; and
e. adding ceramic milling media to the final liquid mixture and mixing for at least 16 hours.

1. A composite comprising:
a plurality of microspheres having:
1) a core comprising a first polymer, having a first surface energy, and
2) a hydrophobic coating, comprising a plurality of hydrophobic nanoparticles, and
disposed upon the surface of the core;
a second polymer, having a second surface energy, wherein the plurality of microspheres are at least partially dispersed within the second polymer,
wherein the second polymer is immiscible in the first polymer; and
wherein the first surface energy is lower than the second surface energy.

2. The composite of claim 1, further comprising hydrophilic nanoparticles.

3. The composite of claim 2, wherein the core of the microspheres comprise the low surface energy polymer and the hydrophilic nanoparticles.

4. The composite of claim 1, wherein the hydrophobic coating extends outward from the core of the microspheres.

5. The composite of claim 1, wherein the second surface energy is at least 30 mJ/m².

6. The composite of claim 1, wherein the second polymer comprises polycarbonate.

7. The composite of claim 1, wherein the second polymer comprises polystryrene.

8. The composite of claim 1, wherein the first surface energy is about 22 mJ/m²or less.

9. The composite of claim 1, wherein the first polymer comprises a polysiloxane.

10. The composite of claim 1, wherein the first polymer comprises polydimethylsiloxane.

11. The composite of claim 2, wherein the hydrophilic nanoparticles comprise an inorganic phyllosilicate nanoclay.

12. The composite of claim 2, wherein the hydrophilic nanoparticles comprise a halloysite nanoclay.

13. The composite of claim 2, wherein the hydrophilic nanoparticles comprise an attapulgite nanoclay.

14. The composite of claim 2, wherein the hydrophilic nanoparticles comprise a nanorod, a nanowire, a nanofiber, a nanotube, or any combination thereof.

15. The composite of claim 1, wherein the hydrophobic nanoparticles comprise perfluorinated halloysite nanoclay, perfluorinated attapulgite nanoclay, or silane modified silicon dioxide.

16. The composite of claim 1, wherein the microspheres have a radius or a diameter of about 1 μm to about 100 μm.

17. The composite of claim 1, wherein the microspheres of the composite provide a surface micro roughness of about 0.1 μm to about 50 μm.

18. The composite of claim 1, wherein the hydrophobic nanoparticles provide a nano roughness of about 10 nm to about 500 nm.

19. A coating comprising the composite of claim 2, wherein the coating is hydrophobic, superhydrophobic, or snowphobic.

20. A method for preparing a composite coating of claim 19, comprising:
mixing a solvent and a polymer having a surface energy less than or equal to 22 mJ/m² to create a first liquid mixture;
mixing hydrophilic nanoparticles into the first liquid mixture to form a second liquid mixture;
mixing hydrophobic nanoparticles into the second liquid mixture to form a third liquid mixture;
adding a polymer having a surface energy of at least 30 mJ/m² to the third liquid mixture to form a final liquid mixture; and
adding ceramic milling media to the final liquid mixture and mixing for at least 16 hours.

21. (canceled)
